(19) United States
(12) Patent Application Publication
(10) Pub. No.: US 2010/0027035 A1
(43) Pub. Date: Feb. 4, 2010

(54) DYNAMIC ADJUSTABLE CUSTOM COLOR PRINTER AND CUSTOM COLOR IMAGES

(76) Inventors: Eric C. Stelter, Pittsford, NY (US); Joseph E. Guth, Holley, NY (US)

Correspondence Address: Andrew J. Anderson, Patent Legal Staff;Eastman Kodak Company, 343 State Street, Rochester, NY, 14650-2201, US

(21) Appl. No.: 12/181,598

(22) Filed: Jul. 29, 2008

(51) Int. Cl. H04N 1/60; G03G 15/01

(52) U.S. Cl. 358/1.9; 399/40

(57) ABSTRACT

An electrographic printer and related method for providing a custom color including printing custom color on a receiver using a multicolor printer including at least one color module capable of printing at least one color image separation of a first color toner on an imaging member by collecting a first color toner from an imaging member, mixing the first color toner with one or more second color toners in a custom color module to produce a blended custom color toner comprising a mixture of at least the first color toner and a second color toner to produce a custom color image separation. Then printing the custom color image separation by transferring the image to a receiver and fusing the image on the receiver.

### FIELD OF TIRE INVENTION

The invention relates generally to electrographic printers or powder coating units. More specifically, it relates to custom color printing by electrographic printers or powder coating units.

### BACKGROUND OF THE INVENTION

Commercial electrophotographic printers, copiers and the like, hereinafter “electrographic printers” or “printers”, are oftentimes classified as falling into one of three different categories: black and white; process color, usually using three or more primary color separations; or spot color, sometimes called accent color. The primary colors used for process color are usually Cyan, Magenta, Yellow, and Black (CMYK). In a spot color printer, a color that is not one of the available primary colors is printed using a toner having the desired spot color in a single color separation, instead of being printed as a process color using two or more color separations. The spot color can also be printed with a mixture of toners that has the desired color as a single color separation. This method of producing a spot color toner is discussed in U.S. Pat. No. 7,316,881 Rimai, et al. “Method of producing a custom color toner”, hereby incorporated by reference.

As is well known in the art, color digital printing involves the formation of color separations, usually as halftone screens for each color, which are used to form a color image. The halftone screens are laid down on a predetermined overlapping relationship to each other, which results in generation of the desired color image. However, the screen pattern for the overlaid color separations can be visible on close inspection, and can produce moiré or graininess. For specific colors used in trademarks and logos, this can be undesirable. For this reason, a single separation is preferred for these specific colors instead of a 4-color separation. This separation can be made using toner marking particles of only one color, or by using a mixture of two or more component toners of two or more colors, that, when blended together, have the appropriate color. The blended toner which is used to print the custom color in a single separation consists of marking particles of more than one color. This separation can contain solid areas, lines, and halftones.

A well-known problem when overlapping two or more halftone screens, if the screens are not properly positioned, is producing a moire pattern or other form of interference. To avoid the moire or other undesirable patterns, precise angle combinations of the screens are required. It is known that increasing the difference in angle of two overlaid screens will result in a smaller pattern, making the pattern less apparent. However, the prior art teaches, see for example, U.S. Pat. No. 6,307,645, the largest possible angle difference between two overlaid screens should be no more than 45° because a 90° screen is essentially the same as 0°, just as a 135° screen is the same as a 45° screen, even in the context of attempting to reduce moire with asymmetrical dots.

In color image printing it has been common practice to use at least three primary colors and, in more cases, three primary colors and black, CMYK. In the case of four-color printing, the printing industry has generated a standardized combination of four halftone angles. The cyan halftone screen is located at 15°, the black halftone screen at 45°, the magenta halftone screen at 75° and the yellow halftone screen at 0°. Since yellow is the lightest and least noticeable color, it can be set at 0°, even though 0° is a highly noticeable angle, and that is only 15° from the nearest neighbor. In some embodiments, the cyan halftone screen is set at 105°, however, with symmetrical dots this is substantially the same as 15°, and the prior art recognizes that even with asymmetrical dots it does not make a large difference.

When the four process color primaries using the above halftone screen angle combinations are overlaid, the resulting moire or other interference patterns are as small as possible. A visually pleasing, or at least acceptable, rosette structure is formed when the individual dots are oriented 30° apart. The traditional graphics art printing is been made using this 15°/45°/75° angle screen design to form a balanced rosette structure.

In the CMYK four-color printing process, the yellow screen is usually designed at 0°, as discussed above, or at 45°. However, the moire pattern resulting from the interaction between the yellow screen and the other three individual screens due to misregistration is not as visually pleasing as a 30° moire pattern (rosette structure). Yellow is a light color, so this additional moire is usually acceptable and not very noticeable in most CMYK four-color printing systems. However, careful examination of prints shows that this yellow moire pattern can be seen in certain composite colors.

Where additional colors are used, such as in a hi-fi color, for example, a five-color, printing system, there is a need to design a fifth screen on top of the original well-balanced CMYK screen set. This is particularly true where the fifth color screen is blue. The blue color screen is placed at the same screen angle and screen frequency as the yellow color screen. The unpleasant moire, which was not noticeable in the yellow color, will now show up in the blue color.

It is thus known that many color printing systems will include five or more printing units using different color colorants. This is usually done to increase the color gamut. Attempting to incorporate these additional colors is noted to be difficult, especially if each color must have a halftone screen with a unique halftone angle. Particularly, once there are more than four screens with attendant screen angles, which must be laid down, the patterning problems, discussed above, are greatly increased. There have been efforts to provide color screen sets for printing which minimize the unpleasant moiré patterns formed, including those caused by the interactions of the yellow screen. WO2005112430 A1, MULTI-COLOR PRINTING USING A HALFTONE SCREEN, Eastman Kodak Company; Gusev et al., incorporated by reference, provides a method for printing a multi-color image using color separation image data representing color separation images for each of plural different colors, the method comprising processing the color separation image data of each of two different colors and generating similar rosette or diamond structures for each of the two colors, wherein the two colors are complementary colors to each other. In the RGB color model (and derived models such as HSV), the complementary colors are: red-cyan; green-magenta; and blue-yellow. In general, however, due to moiré, it is difficult to add additional colors to conventional 4 color screens.

Additional problem can occur with overlying separations of 3 or more colors due to excessive thickness of toner on the image, leading to difficulties in transfer and fusing. Black undercolor removal is frequently done to reduce this problem.

Accent or spot color printers offer a limited set of special colors, usually in addition to black and/or process color. Accent printer original equipment manufacturers (“OEMs”) generally offer a small set of spot color toners. For example, an accent printer OEM might offer a red toner, a blue toner, an orange toner, or some other color toner. The color toners are loaded into the accent printer, which may then print in these toner colors to obtain a specific color on the final receiver for text, a logo, or other imaging applications where two or more superimposed halftone process color separations are not desirable.

A spot color is usually printed as a solid area, but may also be printed as a halftone. Two or more superimposed separations of different colors can create objectionable artifacts: color shifts can be caused by small variations in dot size, dot density, or shifts in registration of the separations; moiré can be created; and undesirable granularity can be produced by the coarseness of the halftone screens.

An accent printer is limited to printing spot color in a single separation in only the colors of its toners. In other words, toner of a particular color must be manufactured or mixed before being used in the printer. While this does allow an accent printer to print spot color, it severely limits the different colors that can be printed by the accent printer.

Printer OEMs have recently begun to offer a much wider range of accent colors by offering a pre-mixed toner and developer. A printer OEM, or other toner distributor, can mix the small set of standard color toners in order to create one of a larger range of colors. Thus, a customer can select a particular accent color and have toner mixed to match that color. The accent color toner is made by mixing the required amount of toner of the traditional primary colors C, M, Y, and K as well as additional accent color toner such as blue, red, or green. The accent color toner produced in this manner is a mixture of blended component color toners of at least two different colors. Once the customer receives the newly mixed toner, it can be loaded into the accent printer, thereby allowing the accent printer to print in that color.

While this process allows an accent printer to potentially print in any gamut of color, it has several limitations. First, the customer ordinarily has to buy and store a relatively large quantity of the accent color, because the distributor would generally not find it profitable to mix and sell only a small amount of custom accent color toner. Additionally, since the new accent color toner is mixed at a distributor's site, the customer ordinarily has to wait several days to get the new accent color toner. Once the new accent color toner is received, the printer must be changed over to the new color. Changing the printer to a new color can take on the order of tens of minutes, which limits its value for short printing runs.

Therefore, there exists a need for an improved method and system for providing custom colors in a printer. Several methods can be used to produce a custom color in a printer: the primary color toners and other available color toners are superimposed, combined, or mixed before deposition on the final image; on an imaging member such as an intermediate transfer member; or a photoconductor, or other similar imaging members that receive a toner image. There also exists a need for an improved method of printing custom colors to reduce problems such as moiré with halftone screens.

### SUMMARY OF THE INVENTION

This invention is directed to electrographic printing using available toner to form one or more adjustable custom colors. The dynamic adjustable custom color printer produces custom colors using primary color toners and accent color toners that are available in the printer.

Primary color toners and accent color toners that are required for the custom color toner, each containing marking particles of one color, are collected from an imaging surface, such as an intermediate transfer member or photoconductor, mixed in a mixing station, and fed to a custom color development station. The blended custom color toner that is produced in this way is a mixture consisting of blended component color toners of at least two different colors, each component toner containing marking particles of one color. Most preferably, the required component color toners can also be collected and mixed in the development station of a custom color module of a multicolor printer. A dedicated collection module can be used to collect the required component color toners, or the custom color module can function as a collection module at one time and as a color module capable of printing a color image separation at another time.

The custom color is printed, using a multicolor printer containing at least one color module, a custom color module, and an imaging member. The color module is capable of printing a color image separation on the imaging member of a first color toner and the custom color module is capable of printing a custom color image separation on the imaging member of a blended custom color toner. The blended color of the custom color image separation is produced by collecting a first color toner from the imaging member, mixing it with the color toner in the custom color module, and printing a custom color image separation using the custom color module. The custom color image separation contains a blended custom color toner that is a mixture of at least the first color toner and a second color toner. The custom color image is transferred to a receiver and fused on the receiver.

In one embodiment the custom colors is printed by toner for the custom color module which is supplied only from other color modules and collected from the imaging member. In another embodiment custom colors are printed by toner for the custom color module which is supplied from other color modules by collection from the imaging member, when the custom color module has an internal toner supply with toner containing marking particles of one color. The custom color module can have an internal toner supply with toner containing marking particles of more than one color. If the custom color module has a toning station and an internal supply of toner particles that is a previously-blended custom color toner, the component toners can develop at different rates, causing a color shift. Additional toner from other color modules in the printer can be used to replenish the component toners so that the custom color is consistent. These color mixing methods have the advantages that a supply of the spot color is not required before the print job is run, process control of the accent color can be implemented using the color monitoring equipment in the printer, and the accent color can be changed or adjusted quickly, in some cases while the printer is operating. This is a useful feature for proofing, during which a series of images can be printed using a range of spot colors.

It is an object of this invention to produce custom colors in a printer on demand. It is another object of this invention to reduce granularity and other unwanted image artifacts by improved rendering of color separations, including improved rendering of custom color in combination with CMYK process color.

An additional objective of the invention is to reduce moiré by printing a combination of halftone screens and continuous tone separations. Accent color can be printed as a continuous tone separation in superposition with a CMYK screen, or as a graylevel screen, with any density modulation in screen lines parallel to the closest complementary CMYK color. Accent color can also be printed as a continuous tone superimposed on a yellow continuous tone and a CMK halftone screen.

### BRIEF DESCRIPTION OF THE DRAWINGS

FIG. 1 shows a schematic diagram of an electrographic marking or reproduction system in accordance with the present invention.

FIG. 2 shows a detailed schematic diagram of a marking unit that is used as the custom color module of the electrographic marking or reproduction system of FIG. 1.

FIG. 3 shows a schematic diagram of an electrographic marking or reproduction system in accordance with the present invention that uses a dedicated toner collection module to collect toner from an intermediate transfer web and to supply it to the custom color module.

FIGS. 4a-4f show a schematic diagram of half toning methods. FIG. 4a is a prior art CMYK screen. FIG. 4b is a CMK screen with Y printed as a continuous tone. FIG. 4c is a CMYK screen with an accent color A printed as a continuous tone. FIG. 4d is a CMK screen with Y and an accent color A printed as continuous tones. FIG. 4e is a CMKA′W screen with Y printed as a continuous tone, dark accent color A′ printed as a gray-level halftone parallel to the K screen, and white or the background color W appearing as a reverse dot parallel to the K screen. FIG. 4f is a CMYKW screen with white or the background color W appearing as a reverse dot parallel to the K screen, and a dark accent color A′ printed as a continuous tone.

### DETAILED DESCRIPTION OF THE INVENTION

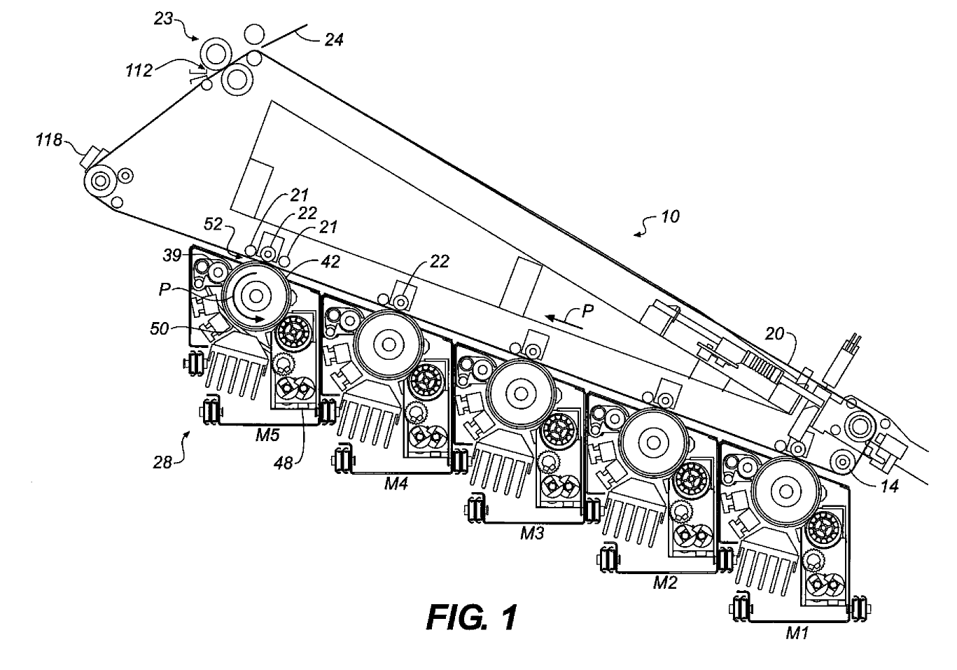

FIG. 1 is an elevation view showing schematically portions of a multicolor printer that is an electrostatographic dynamic adjustable custom color printer, hereafter referred to as the print engine, printer apparatus, or custom color printer 10 suitable for printing of pentachrome images. Although one embodiment of the invention involves printing using an electrophotographic engine having five or more sets of single color image producing or printing stations or modules, the invention specifically involves printing a color separation using blended custom color toner, with at least one of the two or more color toners in the blended custom color toner having been collected from an imaging member in the dynamic adjustable custom color printer. The invention further contemplates that the images formed therein may also be generated using electrographic writers or electrographic printing plates and thus the apparatus of the invention is broadly referred to as an electrostatographic reproduction or printer apparatus.

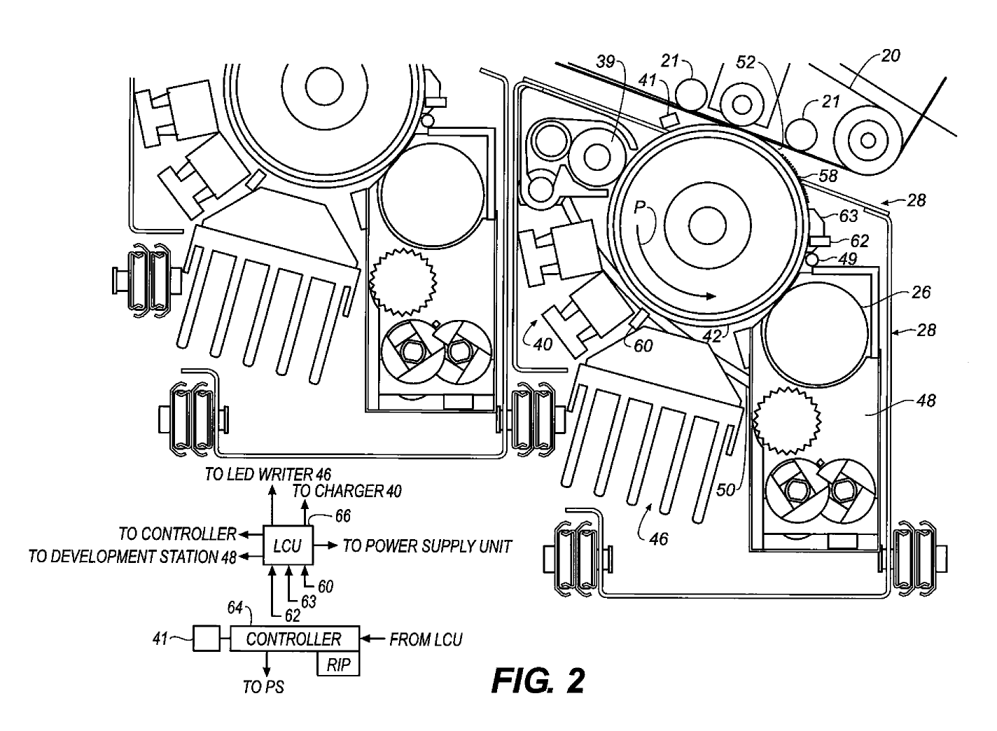

FIG. 1 and FIG. 2 are numbered alike. FIG. 1 shows an electrostatographic printer apparatus 10 having a number of tandemly arranged electrostatographic image forming modules or printing stations which are illustrated as 5 or more color modules M1, M2, M3, M4, and M5 but could be implemented for any number of at least one. The first color module M1 prints a first color image separation of a first color toner, the second color module prints a second color image separation of a second color toner, and so on. FIG. 2 shows an individual custom color module 28 of the type M5 that prints a custom color image separation 58 of a custom color toner. Each of the modules shown can generate a single-color toner image for transfer to an intermediate receiver member or intermediate transfer member 20 (ITM) successively moved through the modules. The intermediate receiver 20, after passing through the five modules can have transferred in registration thereto up to five single-color separations. The image is transferred to a final receiver or substrate 24 at transfer nip 112. In a particular embodiment, M1 forms black (K) toner color separation images, M2 forms yellow (Y) toner color separation images, M3 forms magenta M) toner color separation images, and M4 forms cyan (C) toner color separation images. MS may form one of red (R), blue (B), green (G) or other fifth color separation image. It is well known that the four primary colors cyan, magenta, yellow and black may combine in various combinations of subsets thereof to form a representative gamut or range of colors dependent upon the materials used and process used for forming the colors. The fifth color can be added to improve the color gamut, as will be described below. In addition to adding to the color gamut, the fifth color may also be used as a specialty color toner image such as for accent color or spot color, for making proprietary logos, for example. In the custom color printer 10, the fifth station M5 is used to print a custom color separation, using blended custom color toner that is a mixture of at least a first color toner and a second color toner, where at least one of the colors is collected from intermediate receiver 20. The fifth station, as well as any or all of the stations can include a photoconductive roller or drum 42, or can include other members as will be described below.

The final receiver members are delivered from a paper supply unit (not shown) and transported through transfer nip 112. Each of the modules includes a photoconductive imaging roller 42, a development station 48 containing at least one electrically-biasable toning roller 26, and a transfer backup roller 22. The development station in each module can be replenished as required with toner from a toner supply, typically a toner bottle, by a replenisher (not shown) under process control as explained below to maintain image quality. Thus in module M1, by development of a latent electrostatic image by developer station 48 (D1) a black color toner separation image can be created on the photoconductive imaging roller 42 (PC1), transferred to intermediate transfer member 20 (ITM), and finally, as a single separation or combined with separations from other modules, transferred again to a receiver 24 moving through a transfer station 112, which transfer station includes ITM 20 forming a pressure nip with-a transfer backup rollers 23 (TR). Modules M2, M3, M4 and M5 include similar components, but MS, the custom color module 28, may have additional components described below. A receiver 24 arriving from the supply, is shown having passed between rollers 23 in contact with intermediate transfer member 20. Substrate 24 can have transferred to it separations from modules M1, M2, M3, M4, and M5.

The printer apparatus 10 in FIG. 1 includes a motor (not shown) to advance the printing surface, also referred to as a belt or web 20. The motor advances the belt or web at a high speed, for example 17 inches per second or higher (or 20, 24 inches per second, and faster), in the direction indicated by arrow P, past the series of modules, of the printer apparatus 10. Of course, slower speeds may be implemented in the practice of the invention. The printing machine 10 moves a receiver member 24, which may be a receiver sheet or web, into contact with web 20 at nip 112 to receive the toner image produced by the print modules. Receiver 24 may be plain or coated paper, plastic, metal, or another medium in sheet or web form capable of being handled by printer apparatus 10. Each electrostatographic image-forming module includes an electrical biasing device at first transfer nip 52 for electrostatically biasing movement of the marking particles from photoconductor 42 to the intermediate transfer member 20 as discussed below in conjunction to FIG. 2. After transfer of the marking particle image to intermediate transfer member 20 and subsequent transfer to receiver 24 at the second transfer nip 112, the receiver is detacked from web 20 and transported to a fuser subsystem or assembly (not shown) where the image is fixed onto receiver 24, typically by the application of heat. Alternatively, the image may be fixed to receiver 24 at the time of transfer. A cleaning station 39 such as a brush, blade, or web is also located in the image-forming module adjacent photoconductor 42, and removes residual marking particles. A pre-clean charger (not shown) may be located to assist in this cleaning. After cleaning, the photoconductor 42 is then ready for recharging and re-exposure. A cleaning station (not shown) is also located adjacent the outer surface of web 20. A cleaning station (not shown) is also located adjacent the inner surface of web 20, downstream from transfer rollers 23 and upstream from roller 14.

A main process control sensor MPCS 118, which, can be a transmission or reflection densitometer, is located adjacent web 20 before transfer rollers 23. A densitometer used as a process control sensor MPCS is preferably capable of measuring the color of the toner image, or the amount of each primary color toner in an image. Densitometer MPCS is capable of measuring single color images or multicolor images composed of at least one primary color toner. Other types of sensors or combinations of sensors can be used as a MPCS. For example, the MPCS may measure the thickness of a toner layer, its capacitance, reflectivity or transmissivity of non-visible portions of the electromagnetic spectrum, and other physical characteristics of the image. These measurements may be made individually or in combination for process control.

FIG. 2 shows a representative custom color module 28, including a plurality of electrostatographic imaging subsystems for producing a single color toned image. Included in each module of FIG. 1 and shown in detail in FIG. 2 is a primary charging subsystem 40 for uniformly electrostatically charging a photoconductive imaging member 42 shown in the form of an imaging cylinder. The output of the primary charging subsystem 40 is regulated by a programmable voltage controller that can be controlled to adjust this primary voltage, for example by controlling the electrical potential of a grid and thus controlling movement of the corona charge. Other forms of chargers, including brush or roller chargers, may also be used. The modules also includes an exposure subsystem 46, for example LED writers, for image-wise modulating the uniform electrostatic charge by exposing the photoconductive imaging member to form a latent electrostatic color separation image in the respective color, a development station subsystem 48 for toning the image-wise exposed photoconductive imaging member with toner of the respective color, and a transfer nip 52 for photoconductor 42 and intermediate transfer member 20 adjacent roller 22 for transferring the respective color separation image from the photoconductive imaging member 42 through transfer nip 52 to the intermediate transfer member 20. The modules also include a cleaning brush 39, may include a preclean charge (not shown) and include an erase lamp 41 and a magnetic scavenger 49. As shown in FIG. 1, the image is subsequently transferred from the intermediate transfer member 20 to a receiver member 24. The intermediate transfer member 20 receives a toner image 58 from each module M1, M2, M3, M4, and M5 so that the respective toned color separation images in superposition form a composite multicolor image thereon such as images as known in the prior art containing: text and process color or single primary color tints produced by a regular binary or gray-level halftone pattern, with each individual separation having a single color. The custom color module 28 can make a single color separation 58 containing two or more blended color toners. The blended color toner contains marking particles of at least two colors. The composite images formed using the custom color module and the other color modules can include image areas containing variations on a typical halftone image, such as a primary color halftone on a solid to modify the shade of the solid; or one or more layers of primary color toner representing continuous tone areas of the image.

The invention produces an image containing a halftone separation containing a mixture of different color toners in each dot; or an image containing a continuous tone separation containing different color toners intermixed in a single layer. In the custom color module 28, this can be done by mixing the color toners from at least two of the upstream modules M1, M2, M3 and possibly M4 in downstream module 28 (M5), and preferably mixing the toner in the toning station 48 of module 28. The collected toner from at least one of the upstream modules M1, M2, M3 and M4 can also be mixed with toner supplied to toning station 28 of module 28 from a toner supply bottle (not shown).

As mentioned above, the blended spot color made with the available primaries and accent colors can also be used in screens with the existing single color primaries so that each separation contributes to the final image and the colors of each toner layer combine visually to form a single visible color. For example, this could include a solid area of the mixed spot color as a background to a halftone separation of a single primary color or a halftone screen of a mixed spot color superimposed on a halftone screen of a primary. The advantage of using a single halftone separation of mixed primary color toners instead of several separations of primary color toners is less granularity due to screen structure, and a more uniform image due to greater image exposure for each halftone dot.

Preferably, for superimposed separations containing solid tints, the edges of the solid area for the darkest color separation are of higher density than the center of this separation, and the darkest color separation is larger by at least one pixel in each dimension than the other color separations to provide trapping of the lighter color separations so that slight misregistration is not visible in the final image at the edges of the superimposed layers of color toner. In additional embodiments of the invention, images are created having at least one separation of toner containing marking particles of more than one color mixed in the custom color module 28. These separations can be a continuous tone separation, a gray level halftone separation, or a binary halftone separation.

Development station 48 may contain a two-component developer mix, which comprises a dry mixture of marking particles and carrier particles. Typically the carrier preferably comprises high coercivity (hard magnetic) ferrite particles. As an example, the carrier particles have a volume-weighted diameter of approximately 30μ. The dry marking particles are substantially smaller, on the order of 6μ to 15μ in volume-weighted diameter. Development station 48 may include a biasable roller 26 having a rotatable magnetic core within a shell, which also may be rotatably driven by a motor or other suitable driving means. Relative rotation of the core and shell moves the developer through a development zone in the presence of an electrical field. In the course of development, the marking particles selectively electrostatically adhere to photoconductive imaging roller 42 to develop the electrostatic images thereon and the carrier material remains at development station 48. As marking particles are depleted from the development station due to the development of the electrostatic image, additional marking particles are introduced as needed by process control of a replenisher using an auger, or other supply devices into the development station 48 to be mixed with the carrier particles to maintain a uniform amount of development mixture. This development mixture is controlled in accordance with various development control processes. Single component developer stations, as well as liquid toner development stations, may also be used.

Process control strategies generally utilize various sensors to provide real-time closed-loop control of the electrostatographic process so that printing machine 10 generates “constant” image quality output, from the user's perspective. Real-time process control is necessary in electrographic printing, to account for changes in the environmental ambient of the photographic printer and for changes in the operating conditions of the printer that occur over time during operation or in the intervals between operation (rest/run effects). An important environmental condition parameter requiring process control is relative humidity, because changes in relative humidity affect the charge-to-mass ratio Q/m of marking particles. The ratio Q/m directly determines the density of marking particles that adhere to the photoconductor during development, and thus directly affects the density of the resulting image. System variability that can be present initially or system changes that can occur over time, including changes due to aging of the printhead (exposure station), changes in the concentration of magnetic carrier particles mixed with the marking particles as the marking particles are depleted through use, changes in the mechanical position of primary charger elements, aging of the photoconductor, variability in the manufacture of electrical components and of the photoconductor, change in conditions as the printer warms up after power-on, triboelectric charging of the marking particles, and other changes in electrographic process conditions. Because of these effects and the high resolution of modern electrographic printing, the process control techniques have become quite complex. Process control of the color of the toner image 58 on photoconductor 42 or intermediate 20 is used to control the relative concentrations of the different color toners in custom color module 28.

Associated with the module 28 is a controller 64, the logic and control unit (LCU) 66, which receives input signals from the various sensors associated with the printer apparatus, such as densitometer 63 adjacent photoconductor 42 in the custom color module 28, and sends control signals to the charger subsystem 40, the exposure system 46 and the development station subsystem 48 of the module. Aspects of process control are described in U.S. Pat. No. 6,121,986 incorporated herein by reference. LCU 66 provides overall control of the apparatus and its various subsystems as is well known. LCU 66 will typically include temporary data storage memory, a central processing unit, timing and cycle control unit, and stored program control. Data input and output is performed sequentially through or under program control. Input data can be applied through input signal buffers to an input data processor, or through an interrupt signal processor, and include input signals from various switches, sensors, and analog-to-digital converters internal to printing machine 10, or received from sources external to printing machine 10, such from as a human user or a network control. Each module may also have its own respective controller coupled to the printer apparatus' main controller and main densitometer or process control sensor. MPCS 118 shown in FIG. 1 can also be used to control the color produced by custom color module 28.

As described above, one sensor that is used in custom color module 28 is a process control sensor (PCS) that preferably may be a densitometer 63, which monitors test patches that are exposed and developed in non-image areas of photoconductive imaging roller 42 under the control of LCU 66. The densitometer may include an infrared or visible light LED, which either shines through the toned test patch that can be represented by toner image 58 and imaging member 42 or is reflected by the toned test patch and imaging member 42 onto a photodiode in the densitometer. These toned test patches are exposed to varying marking particle density levels, including fill density and various intermediate densities, so that the actual density and color of the patch can be compared with the desired density of each color marking particles as indicated by the various control voltages and signals. These densitometer measurements are used to control primary charging voltage V_{O}, maximum exposure light intensity E_{O}, and development station electrode bias V_{B}. In addition, Controller 64 controls a marking particle replenishment control signal value or a marking particle concentration setpoint value to maintain the relative concentrations of the two or more toner particles of two or more colors in the toning station 48 of custom color module 28. One of the color toners can be supplied to toning station 48 from a toner supply. At least one other color toner is collected from intermediate transfer web 20 as explained below and supplied to toning station 28. The toned test patches are formed in interframes so that the process control can be carried out in real time without reducing the printed output throughput. Other sensors useful for monitoring process parameters in printer apparatus 10 are electrometer probe 60, mounted downstream of the corona charging station relative to direction P of the movement of photoconductor 42, and electrometer probe 62, mounted between toning station 28 and transfer nip 52, as well as a toner concentration control sensor in toning station 48 (not shown). An example of an electrometer is described in U.S. Pat. No. 5,956,544 incorporated herein by this reference.

The exposure subsystem 46 exposes the photoconductor 42 to light that discharges selected pixel locations of the photoconductor, so that the pattern of localized voltages across the photoconductor corresponds to the image to be printed. An image is a pattern of physical light, which may include characters, words, text, and other features such as graphics, photos, etc. An image may be included in a set of one or more images, such as in images of the pages of a document. An image may be divided into segments, objects, or structures each of which is itself an image. A segment, object or structure of an image may be of any size up to and including the whole image. Image data to be printed is provided by an image data source 41, which is a device that can provide digital data defining a version of the image, and may be the controller or another source, such as the internet or portable storage member. Such types of devices are numerous and include computer or microcontroller, computer workstation, scanner, digital camera, etc. These data represent the location and intensity of each pixel that is exposed by the printer. In a preferred embodiment of data source 41, image data in combination with control signals from LCU 66 are provided to a raster image processor (RIP). The RIP converts the digital images (including styled text) from their form in a page description language (PDL) to a sequence of serial instructions for the electrographic printer in a process commonly known as “ripping” and which provides a ripped image to an image storage and retrieval system known as a Marking Image Processor (MIP). This ripped image is printed by exposure system 46.

Additional PCS members provided for control may be assembled about the various elements, such as for example a meter 60 for measuring the uniform electrostatic charge and a meter 62 for measuring the post-exposure surface potential with a patch area of a patch latent image formed from time to time in a non-image area. The PCS densitometer 63 may be used to measure the density and color of images or test patches produced on imaging member 42. Further details are also provided in U.S. Pat. No. 6,608,641, the contents incorporated herein by reference.

The electrostatic image is developed, preferably using the well-known discharged area development technique, by application of pigmented marking particles to the latent image bearing photoconductive drum by the respective development station 48 which development station preferably employs so-called “SPD” (Small Particle Development) developers. Each of development stations 48 contains a toning roller 26 that is electrically biased by a suitable voltage to develop the latent image, which voltage may be supplied by a power supply or by individual power supplies (not illustrated) under control of LCU 66. Preferably, the developer is a two-component developer that includes toner marking particles and magnetic carrier particles. The custom color module 28 includes development station 48, can produce individual color separations in similar manner to that of the other modules.

In a first embodiment of the invention using the configuration shown in FIG. 1, color toner deposited on intermediate transfer member 20 from at least two of modules M1, M2, M3, and M4 is collected and mixed on roller 26 of the development station 48 of module M5. Toner collection from the intermediate transfer member 20 is done by an appropriate combination of biases at transfer nip 52, followed by motion of the toner into toning station 48. This can be done by biasing roller 22 and photoconductor 42 of the custom color module 28 as well as an appropriate combination of biases on photoconductor 42 and roller 26 of toning station 48. The toner deposited on web 20 by modules M1, M2, M3, and M4 can be in the form of superimposed layers or, preferably, deposited in alternating areas of intermediate transfer member 20. Printing can be interrupted and toner added to the custom color module 28 occasionally in a skipframe based on input from the PCS densitometer 63.

If a blended custom color is to be printed in imagewise fashion, within a frame or frames on intermediate member 20 where no single color separations are present, M1 can be used to supply directly onto web 20 a required amount of a first primary color, M2 can be used to supply a required amount of a second primary color as a layer deposited on the first primary color or as a patch in an adjacent area of web 20, and M3 and M4 can be used to supply required amounts of additional primary colors to make the desired spot color in the custom color module 28. In a first embodiment that relies on transferring onto photoconductor 42 of the custom color module 28, at least one primary color toner from web 20, during the interframe, the photoconductor 42 is biased relative to backup roller 22 by exposing or biasing photoconductor 42 with an image that will attract toner from locations on web 20. These toners of at least one primary color are deposited into toning station 48 of the custom color module 28 using an appropriate bias voltage for toning station 48. This process is continued for subsequent interframes until the developer nap of toning station 48 has sufficient toner of each primary color to be used as an accent color development station when biased normally.

In an additional embodiment, if toning station 28 is supplied with an additional color toner, such as blue toner from a toner supply using a replenisher, the collected toner can be mixed with the toner from the toner supply of toning station 28.

The printer is then used to print composite color images on the receiver using M1, M2, M3, M4, and the custom color module 28, where the custom color module 28 is used as an accent color print unit and is electrically biased for conventional printing, using the blended component color toners, with at least one color toner having been collected from the intermediate transfer member 20. The controller 64 monitors the color of the output using the MPCS 118 and densitometer 63 in module 28 and adjusts modules M1, M2, M3, M4, and M5 appropriately. In response to a change in the color produced by the custom color module 28 or to prevent a color change, the controller uses an interframe or produces at least one skip frame in which appropriate amounts of component color toners are deposited on web 20 by print units M1, M2, M3, and M4. These are used to replenish developer station 48 of the custom color module 28 by transferring toner from web 20 to photoconductor 42, and subsequently depositing the toner from photoconductor 42 into toning station 48 by the appropriate bias voltages on web 20, roller 22, photoconductor 42, and toning roller 26 of toning station 48.

For example, to transfer negative toner from intermediate member 20 to toning station 48 in the custom color module 28, photoconductor 42 is discharged, toning roller 26 is biased to a positive voltage, and backup roller 22 is biased negative. The cleaning station 39 is disengaged. Preferably, the electrode in photoconductor 42 is grounded, backup roller 22 is biased at least −150 VDC and more preferably −300 VDC, and toning station 48 is biased at least 150 VDC, and more preferably at 300 VDC. An AC bias voltage may be used in superposition with the DC bias voltage on the toning roller to improve transfer from the photoconductor to toning station 48. A magnetic scavenger 49 may be required downstream from toning station 48 to remove carrier transferred from the toning station to the photoconductor by the bias voltage. Also, grounded contact bars or rollers 21 may be required on one or both sides of the roller 22 adjacent the custom color module 28 to electrically isolate this roller from the rest of the system.

To develop an accent color image, conventional voltages are used as is known in the art. Chargers 40 are used to charge the photoconductor to −300 to −700 V, the image is exposed to approximately less than −150 V for a discharge area development process, the toning bias is set approximately 80 V more positive than the photoconductor voltage, and a positive transfer bias is used.

In an alternate embodiment, when the custom color module is functioning as a collection module, the ground layer of photoconductor 42 of the custom color module 28 can be biased to a positive voltage with respect to roller 22 or web 20, to attract toner from web 20, and the absolute voltage of other process members, including toning station 48, can be changed to maintain the relative voltages implied above.

In these embodiments, when the custom color module is functioning as a collection module, toner is moved from the imaging member 20 to the development station 48 of the custom color module by biasing the nip 52 with photoconductor 42 of the custom color module to receive toner from the imaging member 20 and by biasing the development roller 26 of toning station 48 of the custom color print unit to receive toner from the photoconductor 42.

The dynamic adjustable custom color printer produces custom colors using color toners available in the printer. The available color toners are collected and mixed in a mixing station and fed to a custom color development station. For example, an orange spot color is created by combining appropriate proportions of yellow and magenta toner. Primary colors that are available in the press and are used for process color can also be mixed with a previously prepared spot color, such as a blue toner and developer. The previously prepared spot color toner and developer can be installed in a toning station 48 and mixed with other color toners available in the printer 10 to change the hue or value of the accent color toner. For example, blue can be changed to dark blue or navy by adding black. The blue accent color can be a combination of cyan toner and magenta toner, or it can consist of blue toner.

In one embodiment, if one of the color modules of the printer is designated as a custom color module, and is printing an accent color such as blue using a developer station with a supply of blue toner, additional toner from other color modules in the printer can be mixed with the existing blue toner in the custom color module to produce a different custom color, for example, navy blue or sky blue. Additional toner from other color modules in the printer can be added to the custom color module to modify the color if the custom color module is printing an accent color from a toning station with an internal supply of toner that contains marking particles of only one color, or if the supply contains a previously-prepared mixture of blended component color toners of at least two different colors.

In another embodiment, when the custom color module is functioning as a collection module, cleaning station 39 of the custom color module 28 can be used to remove toner from photoconductor 42 and deposit this material into toning station 48 by a suitable channel 50 unique to the custom color module 28, shown in FIG. 1 and FIG. 2 as a dotted line 50 between cleaning station 39 and toning station 48. Toner is collected from the imaging member 20 to the development station of the custom color print unit by biasing the nip 52 with photoconductor 42 of the custom color print unit to receive toner from the imaging member 20 and by using the cleaning station 39 of the custom color print unit to move toner from the photoconductor 42 through channel 50 to the toning station 48.

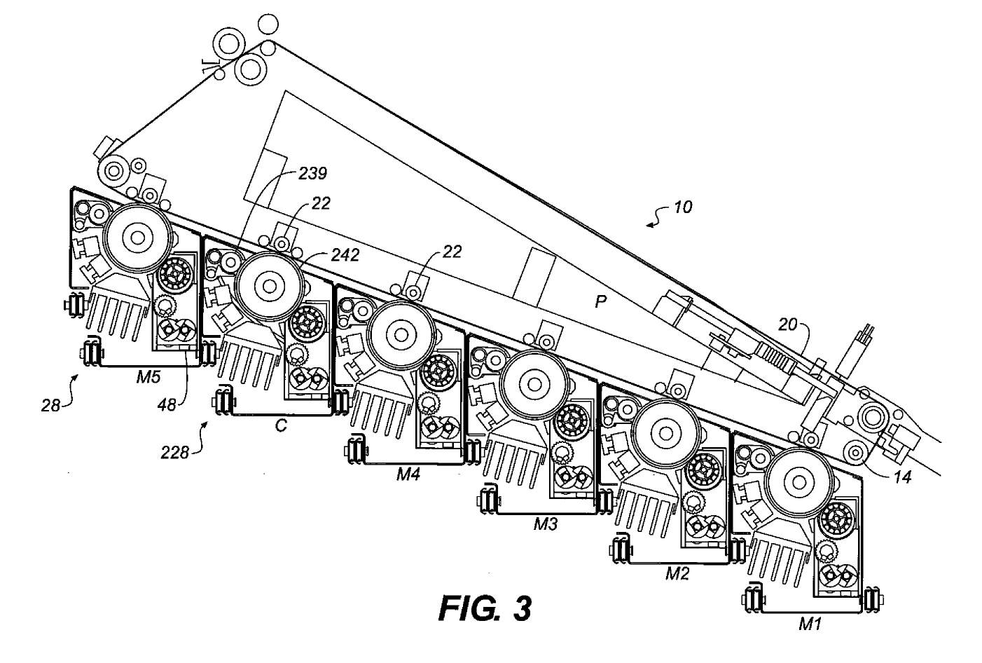

FIG. 3 shows another embodiment of the printer apparatus 10 having an in-line toner collection module 228 (station C) dedicated to removing toner from the belt 20 and depositing it into toning station 48 of the custom color module 28. In this embodiment, custom accent colors are made using the appropriate color toner from stations M1, M2, M3 and M4 using the configuration shown in FIG. 3. Toner is collected from the imaging member 20 to the development station 48 of the custom color print unit 28 by a dedicated collection station 228 through a channel 250 depositing toner into toning station 48. Station 228 (C) of FIG. 3 has a polymeric or metallic biasable transfer member 242 onto which toner is collected from an interframe or otherwise empty frame of belt 20, similar to the previously disclosed embodiments. This toner is cleaned from 242 by cleaning station 239, and deposited into toning station 48 of the custom color module 28 via channel 250. Toner can be added during an interframe without interrupting printing, based on signals from MPCS 118, or pixel counting, or other means. In a preferred embodiment, to collect negative charging toner, transfer member 242 is biased at least 150 VDC and more preferably 300 VDC more positive than backup roller 22 adjacent station C, and cleaning station 239 is biased at least 150 VDC, and more preferably at least 300 VDC more positive than transfer member 242. The bias between backup roller 22 and transfer member 242 can be determined by changing the bias of roller 22, of member 242, or by changing both voltages from the normal state in which no toner is removed from the belt 20 by station 228 (C). An AC bias voltage may be used in addition to DC voltages to improve transfer between members. This embodiment has the advantage that the custom color module 28 can print continuously if appropriate amounts of each primary color from station M1, M2, M3, and M4 are deposited under process control on the interframes between images, and replenished into toning station 48 by station C. In its simplest embodiment, 228 (C) can consist of a cleaning station similar to 239 that can be enabled or disabled as needed to clean toner from web 20, with a channel 250 feeding toner to toning station 48.

In any of these embodiments, process control of the accent color image printed by the custom color module 28 can be done using MPCS 118 adjacent belt 20, or by using densitometer 63 adjacent photoconductor 42 of the custom color module 28 in conjunction with LCU 66 and Controller 64. As mentioned above, process control of the mixed colors can be done during an interframe. In this case, the colors deposited on the photoconductor are transferred to the intermediate 20, transfer is disengaged or disabled, and they are cleaned off by a web cleaner (not shown) for web 20.

An additional aspect of the custom color printer 10 is that custom accent color can be used in image rendering. Accent color can be printed as a separate separation, similar to traditional practice on flexo or offset presses. In the present invention, the accent color can be utilized in the image rendering process. An aspect of the invention is to reduce moiré by printing a combination of halftone screens and continuous tone separations. For example, to reduce moiré, the cyan halftone screen is located at 15°, the black halftone screen at 45°, the magenta halftone screen at 75° and yellow is printed as a continuous tone separation in the background of the CMK screen. Accent color can be printed as a continuous tone separation in the background of a CMYK screen, or as a graylevel screen, with any density modulation in screen lines parallel to the closest complementary CMYK color. Accent color can also be printed as a continuous tone superimposed on a yellow continuous tone and a CMK halftone screen.

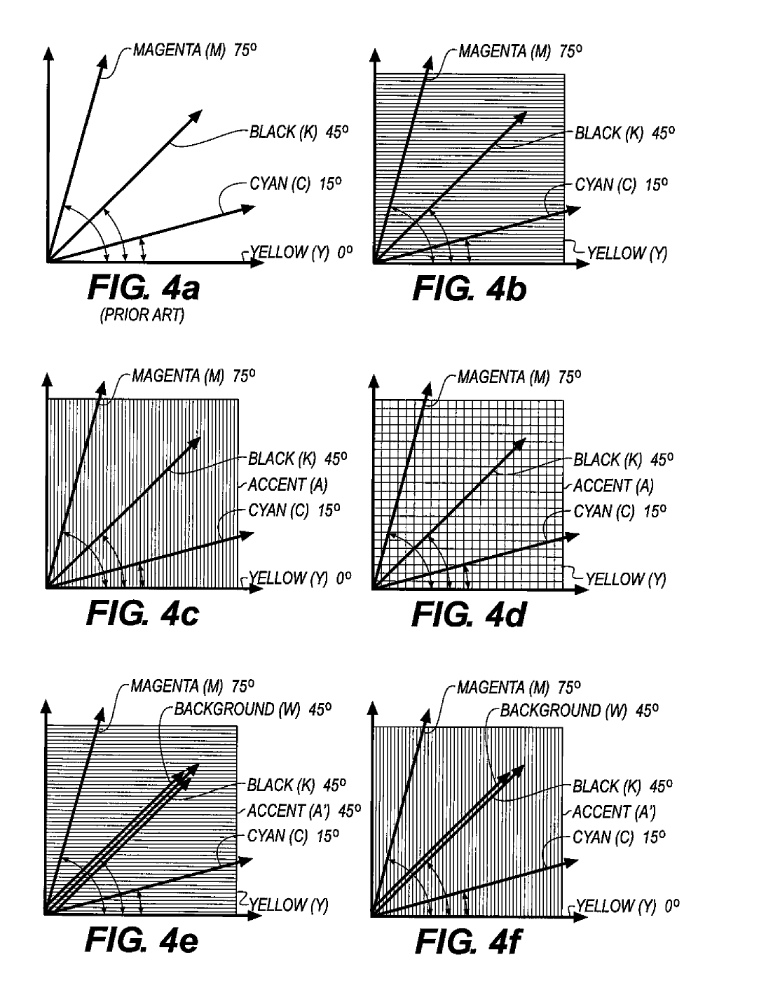

FIGS. 4a-4f show a schematic diagram of half toning methods. FIG. 4a is a prior art CMYK screen, in which Black (K) is at 45° with respect to horizontal, Cyan and Magenta are 30° from Black, and Yellow is at 0° with respect to horizontal. FIG. 4b is a CMK screen with Y rendered and printed as a continuous tone in the background, reducing granularity. FIG. 4c is a CMYK screen with an accent color A printed as a continuous tone. Undercolor removal techniques, such as those disclosed in U.S. Pat. No. 7,218,420, previously incorporated by reference, can be used, where the accent color is treated as an undercolor after black or grey color removal has been performed. Alternately, undercolor removal can be used for the accent color before removing black or gray. These methods have the advantage of further reducing toner stack height for halftone images. FIG. 4d is a CMK screen with Y and an accent color A printed as superimposed continuous tones. FIG. 4e is a CMKA′W screen with Y printed as a continuous tone in the background, dark accent color A′ printed as a gray-level or other halftone parallel to the K screen, and white (or the background color of the receiver) W appearing as a reverse dot parallel to the K screen. FIG. 4f shows a CMYKW screen with accent color A′ printed as a continuous tone in the background, and white (or the background color of the receiver) W appearing as a reverse dot parallel to the K screen.

The separations are made by rendering each color separately. In particular, for continuous tone accent color and continuous tone yellow with CMK half toning, separations are made starting with the original image data; performing undercolor removal for the spot color, followed by undercolor removal for black, followed by undercolor removal for yellow, and then rendering the CMK screens. Rendering in this case can consist of: the accent color (A) printed with a mixed accent color toner in a separation that can include continuous tone, solid areas, halftones, lines, and characters as well as other image elements; CMK separations that have had black undercolor removal and yellow undercolor removal; and yellow printed as a continuous tone separation. In this implementation, white, or the background color of the receiver, (W) is rendered as a reverse dot (e.g. a white dot primarily surrounded by the accent color and yellow) with screen lines parallel to the black screen. In any small area of the image where the density of CMYKA is below a minimum threshold, White (or the underlying color of the substrate) is rendered as a reverse dot. Continuous tone and halftone can both be used in the same separation, for example, depending on the presence of other primary colors in the region. If a graylevel screen is used with a dark accent color A such as navy blue, in a region where C, M, or K halftone dots are present, the modulation in the graylevel screen for that color is preferably in screen lines that are parallel to the black screen.

FIGS. 4b, 4c, 4d, 4e, and 4f show a color image containing color separations, in which the color image contains at least one continuous tone separation superimposed on halftone separations of C, M and K. For images containing a separation of a collected, blended custom color superimposed with separations of C, M, Y, and K, undercolor removal can be performed using the custom color before generating the C, M, Y and K separations. Images that are improved by undercolor removal using the custom color are shown in FIGS. 4c, 4d, 4e, and 4f To reduce granularity, as shown in FIG. 4e, a color image containing a continuous tone separation of a collected, blended custom color can contain reverse dots in which the background color of the receiver appears.

The invention will be described and illustrated herein in connection with the patterning of thin film electrode layers by the techniques of electrophotography and electrostatic printing. It will be readily understood by those skilled in the art that the invention will be in general, applicable to any electrographic technique which uses marking particles for defining image patterns.

What is claimed is:

1. A method of printing custom color on a receiver using a multicolor printer including at least one color module capable of printing at least one color image separation of a first color toner on an imaging member, the method comprising the steps of:
a. collecting a first color toner from an imaging member, each color toner comprising fusible marking particles of one color;
b. mixing the first color toner with one or more second color toners in a custom color module to produce a blended custom color toner comprising a mixture of at least the first color toner and a second color toner to produce a custom color image separation; and
c. printing the custom color image separation by transferring the image to a receiver and fusing the image on the receiver.

2. The method of claim 1, the imaging member comprising a photoconductor.

3. The method of claim 1, the first and second color toners comprising toner supplied only from other color modules and collected from the imaging member.

4. The method of claim 1, the custom color module comprising an internal toner supply with toner containing marking particles of one or more colors.

5. The method of claim 1 the imaging member comprising an intermediate transfer member

6. The method of claim 5, further comprising moving toner from the imaging member to a custom color module development station 48 by biasing a nip 52 with a custom color module photoconductor 42 to receive toner from the imaging member 20 and further biasing a toner station development roller to receive toner from the photoconductor.

7. The method of claim 5, further comprising collecting toner by moving toner from the imaging member to a development station of the custom color print unit by biasing a nip 52 with a photoconductor 42 of the custom color print unit to receive toner from the imaging member and by her using the cleaning station 39 to move toner from the photoconductor through a channel 50 to a toning station 48.

8. The method of claim 5, further comprising collecting toner by moving toner from the imaging member to the development station 48 using a dedicated collection station 228 comprising a channel 250 and further depositing toner into a toning station 48.

9. The method of claim 1, further comprising depositing collected color toner in one of an interframe between images on the imaging member and a skipframe between images on the imaging member.

10. The method in claim 1, further comprising:
a. obtaining data representing an image including identifying and removing an accent color component comprising said blended component color toners in the image;
b. generating an accent color component screen for at least a portion of the image as color separations;
c. generating an image color screen of the image minus the accent color component for at least a portion of the image comprising removing the primary color colorants where the accent screen has the same angle as the color separations that is most nearly complementary to produce a combined color screen; and
d. combining the image color screen and the accent color component screen.

11. A method of generating a full color image in an electrographic printer from two or more different colorants, including an accent color, having color toner separations, the method comprising the steps of:
a. obtaining data representing an image including identifying and removing an accent color component comprising said blended component color toners in the image;
b. generating an accent color component screen for at least a portion of the image as color separations;
c. generating an image color screen of the image minus the accent color component for at least a portion of the image comprising removing the primary color colorants where the accent screen has the same angle as the color separations that is most nearly complementary to produce a combined color screen;
d. combining the image color screen and the accent color component screen; and
e. printing the combined color screen.

12. The method in claim 11 wherein each of said colorants comprise different primary colorants.

13. The method in claim 12 wherein said different basic colorants are one or more of cyan, magenta, yellow and black colorants.

14. The method in claim 11 wherein said printing step further comprises stitching together portions of an image to print the whole image such that each layer is printed separately.

15. The method of claim 11, wherein said blended component color toners comprise collected toner from a collection module that are mixed in the development station of a color module of a multicolor printer by an appropriate combination of biases on photoconductor 42 and roller 26 of the custom color module 28 to form a desired blended custom color toner.

16. The method of claim 15, further comprising collected toner from an in-line toner collection module 228 (station C) dedicated to removing toner from the belt 20 and depositing it into toning station 48 of the custom color module 28.

17. The method of claim 16, said collected toner collected from one or more of an interface or otherwise empty frame of printing surface.

18. A document producing apparatus for printing custom color on a receiver using a multicolor printer, the apparatus comprising:
a. an imaging member;
b. a development station for depositing one or more layers of toner to form a predetermined image that represents a color image;
c. a controller for controlling the application of each layer to form the final receiver;
d. a collection module comprising a collection device for collecting collected toner comprising two or more single-color component color toners from the photoconductor;
e. a mixing device for mixing said single-color component color toners in the development station of said color module by an appropriate combination of biases on photoconductor and roller of the custom color module to form a desired blended custom color toner;
f. a printer for depositing said blended custom color toner in one or more layers superimposed on the printing surface [intermediate web] and printing a combined color screen of the blended custom color toner and other toner; and
a fuser for fusing the toner by applying heat and pressure.

19. The apparatus according to claim 18 said collection module farther comprising an in-line toner collection module 228 (station C) dedicated to removing toner from the belt 20 and depositing it into toning station 48 of the custom color module 28

20. The apparatus according to claim 18 said collection module further comprising a cleaning station 39 of the custom color module 28 that removes toner from photoconductor 42 and deposits into toning station 48 comprising a color channel.

21. A method of generating a color image containing color separations, in which the color image contains at least one continuous tone separation superimposed on halftone separations of C, M and K using blended color components wherein said blended components comprise collected toner from a collection module that are mixed in a color module development station.

22. A method of generating a color image containing color separations, in which the image contains a continuous tone separation of a collected, blended custom color superimposed with separations of C, M, Y, and K, with undercolor removal performed using the custom color before generating the C, M, Y and K separations.

23. A method of generating a color image containing a continuous tone separation of a collected, blended custom color containing reverse dots in which the background color of the receiver appears wherein said blended custom color comprises collected toner from a collection module that are mixed in a color module development station.
